(19) United States
(12) Patent Application Publication
(10) Pub. No.: US 2025/0209630 A1
(43) Pub. Date: Jun. 26, 2025

(54) METHOD AND DEVICE FOR VIDEO COMMUNICATION

(71) Applicant: SAGEMCOM BROADBAND SAS, BOIS-COLOMBES (FR)

(72) Inventors: Jad Abdul Rahman OBEID, BOIS-COLOMBES (FR); Vincent SCHOTT, BOIS-COLOMBES (FR)

(21) Appl. No.: 18/981,258

(22) Filed: Dec. 13, 2024

(30) Foreign Application Priority Data
Dec. 21, 2023 (FR) 2314754

(51) Int. Cl. G06T 7/11; G06V 10/25; G06V 40/16

(52) U.S. Cl. CPC G06T 7/11; G06V 10/25; G06V 40/161; G06V 40/171; G06T 2207/10016; G06T 2207/20132; G06T 2207/30201

(57) ABSTRACT

Disclosed is video communication method implemented by a device comprising a processor and a memory comprising software code, the processor executing the software code causing the device to implement the method, the method comprising:
obtaining an image generated by a camera;
detecting one or more people in the image;
in the event that one or more persons are detected, checking for each person a criterion indicating whether the person should or should not be part of the video communication;
processing the image to erase from the image the detected person(s) who should not be part of the video communication;
transmitting the processed image.

Also disclosed are an implementation device, a storage medium, and a computer program product.

### CROSS-REFERENCE TO RELATED APPLICATIONS

The present application claims priority to French Application No. 2314754 filed with the French National Institute of Industrial Property (INPI) on Dec. 21, 2023, and entitled “METHOD AND DEVICE FOR VIDEO COMMUNICATION,” which is incorporated herein by reference in their entirety for all purposes.

### Technical Field

A method and device for video communication are described. The method and device can be used, for example, as part of a video calling or videoconferencing application.

### Technical Background

Video calling and videoconferencing systems have found numerous applications in both the professional and private spheres, or in areas that straddle them both, notably through teleworking. The boundary between the private sphere and the professional environment has thus become permeable. As such, a video call can be considered as an intrusion, because of the information it provides to a user about the physical, family, or professional environment of whoever is on the other end of the call. Various solutions have been proposed, including the possibility of blurring the image background, or superimposing a virtual background. However, such solutions are not suitable for situations where people intrude into the picture plane.

### SUMMARY

One or more embodiments relate to a video communication method implemented by a device comprising a processor and a memory comprising software code, the processor executing the software code, causing the device to implement the method, the method comprising:
obtaining an image generated by a camera;
detecting one or more people in the image;
in the event that one or more persons are detected, checking for each person a criterion indicating whether the person should or should not be part of the video communication;
processing the image to erase from the image the detected person(s) who should not be part of the video communication;
following the processing of the image to erase from the image detected person(s) who should not be part of the video communication, cropping the processed image to obtain a cropped processed image, the cropping being configured to remove at least left and right sidebands from the processed image, the sidebands being of a width likely to contain one or more persons before it becomes possible to detect them, the transmission being performed with the cropped processed image.

The width of the deleted bands is chosen so that a person entering the image does not appear in the cropped image. The width of the deleted bands can also simply be a percentage of the dimensions, for example 5% of the image width or height Cropping creates a wider detection margin, to increase the chances of good detection for people at the edge of the unprocessed image.

In one or more embodiments, detection comprises identifying one or more first areas of the image, each first area comprising a face.

In one or more embodiments, detection further comprises:
identifying one or more second areas of the image, each second area comprising a body;
associating, on the basis of an association criterion, a first area and a second area to form a representation of a person in the image.

In one or more embodiments, the method comprises, for a given first area which cannot be associated with a second area on the basis of the association criterion, determining a third area, where the third area is an area of the image dependent on the given first area and intended to serve as a second area associated with the given first area to form a representation of a person in the image for image processing.

In one or more embodiments, the method comprises, when a second area cannot be associated with a first area, marking this second area as part of a person who should not participate in the video communication, the representation of this person then comprising only the second area.

In one or more embodiments, the method comprises extracting, from each first area, characteristic parameters of the face of each first area, said characteristic data being adapted to enable to determine, from a database, whether a person corresponding to a face should or should not be part of the video communication.

In one or more embodiments, said database comprises:
either characteristic face parameters for one or more persons authorized to participate in the video communication;
or at least one of:
characteristic parameters for one or more faces and, for each face, an indication that the person corresponding to the face should be part of the video communication; and
characteristic parameters for one or more faces, and for each face, an indication that the person corresponding to the face should not be part of the video communication.

In one or more embodiments, the method comprises an initialization of the database with data stored in advance.

In one or more embodiments, the method comprises augmenting the database by:
identifying one or more first areas comprising a face, during a time interval from the start of the video communication;
extracting, from each first area, characteristic parameters of the face of each first area;
storing the characteristic face parameters of the face of each first area with a respective indication that the person corresponding to the face should be part of the video communication.

According one or more embodiments, the image processing comprises
obtaining a mask from representations of people who should not be part of the video communication;
obtaining an image processed on the basis of the mask, of the image obtained from the camera, and of a processed image obtained previously.

Another aspect relates to a device comprising a processor and a memory comprising software code, the processor executing the software code causing the device to implement one of the methods described and in particular one of the above methods.

Another aspect relates to a television decoder comprising a device as above.

Another aspect relates to a computer program product comprising instructions which when executed by at least one processor cause one of the described methods to be executed, in particular one of the above methods.

Another aspect relates to a non-transitory storage medium comprising instructions which when executed by at least one processor cause one of the described methods to be executed, in particular one of the above methods.

### BRIEF DESCRIPTION OF THE FIGURES

Further features and advantages will become apparent from the following detailed description, which may be understood with reference to the attached drawings in which:

FIG. 1 is a schematic diagram of a system comprising a device according to one or more embodiments.

FIG. 2 is a flowchart of a method according to one or more exemplary embodiments;

FIG. 3 is a schematic diagram of an image before and after processing by a method according to one or more embodiments;

FIG. 4 is a flowchart of the method according to one or more exemplary embodiments;

FIG. 5 is a flowchart detailing the substeps of one step of FIG. 4 according to one or more exemplary embodiments;

FIG. 6 is a schematic diagram showing body and face detection according to one particular embodiment;

FIG. 7 is a schematic diagram showing the body-face association principle;

FIG. 8 is a schematic diagram showing the creation of a fictitious body for a non-associated face;

FIG. 9 is a schematic diagram showing the obtaining of two vectors from two respective faces;

FIG. 10 is a schematic diagram showing the classification principle according to one or more exemplary embodiments;

FIG. 11 is a schematic diagram showing two alternative variants of a mask of a current image;

FIG. 12 is a schematic diagram showing the various steps in constructing of a mask implementing semantic segmentation according to one exemplary embodiment;

FIG. 13 is a schematic diagram showing the composition of the image S_t;

FIG. 14 is a schematic diagram showing the problem of an undetected person, partially visible in the image captured by the camera;

FIG. 15 is a schematic diagram of a method for reducing the impact of an undetected person near an edge of the image;

FIG. 16 is a schematic flowchart showing the alignment of a face according to one or more exemplary embodiments.

### DETAILED DESCRIPTION

In the following description, identical, similar or analogous elements will be referred to by the same reference numbers. The block diagrams, flowcharts and message sequence diagrams in the figures shows the architecture, functionalities and operation of systems, apparatuses, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller prompts the system or apparatus to implement all or part of the functionalities of the blocks and/or steps of the processes or methods according to the exemplary embodiments. The software code can be stored in non-volatile memory or on a non-volatile storage medium (USB key, memory card or other medium) that can be read directly or via a suitable interface by the processor or controller.

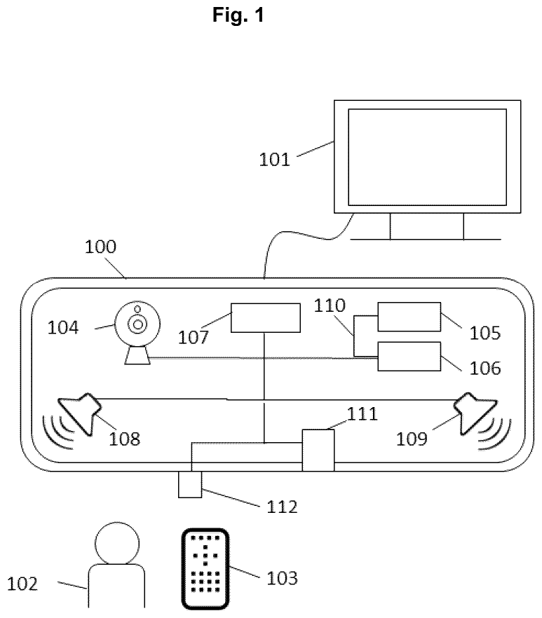

FIG. 1 is a schematic diagram of a system showing one or more non-limiting embodiments. The system shown in FIG. 1 comprises a device 100 and a display screen 101. The device 100 comprises a processor 105, a non-volatile memory 106 comprising software code, and a working memory 107.

In addition, the various components of the device 100 are controlled by the processor 105, for example via an internal bus 110.

The device 100 further comprises an interface (not shown) through which it is connected to the screen 101. This interface is, for example, an HDMI interface. The device 100 is adapted to generate a video signal for display on the screen 101. The video signal is generated, for example, by the processor 104. The device 100 further comprises an interface 111 for connection to a communications network, such as the Internet.

The device 100 further comprises a camera 104 and a microphone 112. The software code comprise a video communication application (video calling, videoconferencing, etc.) using the camera and microphone.

The device 100 can optionally be controlled by a user 102, for example, using a user interface, shown here in the form of a remote control 103. The device 100 may also optionally comprise an audio source, shown as two speakers 108 and 109. The device may optionally comprise a neural processing unit (NPU), whose function is to accelerate the calculations required for a neural network.

In some contexts, the device 100 is, for example, a digital TV receiver/set-top box, while the display screen is a TV set. However, the invention is not limited to this specific context and can be used in the context of any video communication, such as a video communication application on a cell phone, computer etc.

The system shown in FIG. 1 is given for illustrative purposes to clearly present the exemplary embodiments and an actual implementation may comprise more or fewer components. In addition, certain components described as being integrated into the device 100 may be external to the device and connected to it via a suitable interface—this is particularly the case for the camera 104 or microphone 112. On the other hand, certain system components described as external to the device 100 can be integrated into the device—for example, the display screen or the user interface 103.

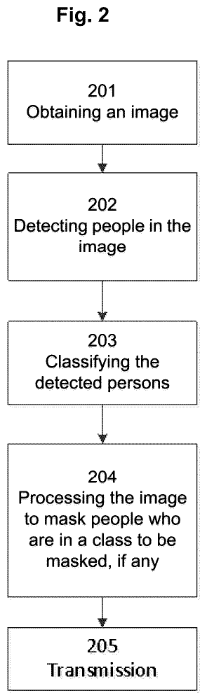

FIG. 2 is a flowchart of a method according to one or more exemplary embodiments. In 201, an image is captured by the camera 104. In 202, the image is analyzed to detect whether one or more people are present. In 203, a classification of detected persons is carried out. This classification indicates whether a person should be masked or not. The image is transformed in 204 to mask any people who need to be masked.

The resulting image is then ready for transmission to one or more recipients, in 205. This transmission may be preceded by further processing of the image and/or previous and subsequent images, such as compression, adding elements to the image, etc.

In the following, we will refer to a person to be masked as an ‘unauthorized person’ (‘UP’) and to a person not to be masked as an ‘authorized person’ (‘AP’).

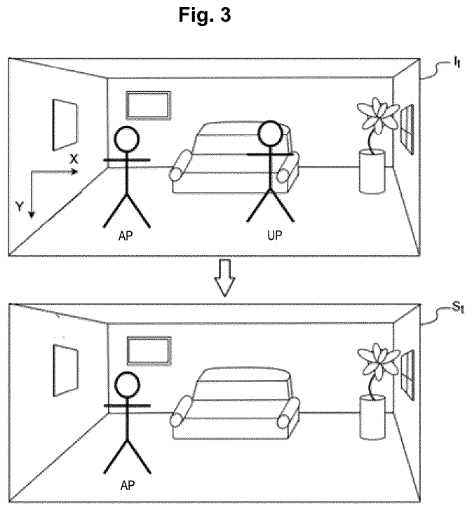

FIG. 3 schematically shows an image before processing (I_t, top image) and after processing (St, bottom image). The image I_t shows a room filmed by the camera. There are two people in this room, one authorized (‘AP’) and one unauthorized (‘UP’). In the transformed image, the unauthorized person is masked, that is hidden. In the example shown in FIG. 3, the person UP is replaced by the background of the room that would appear if the person UP were absent.

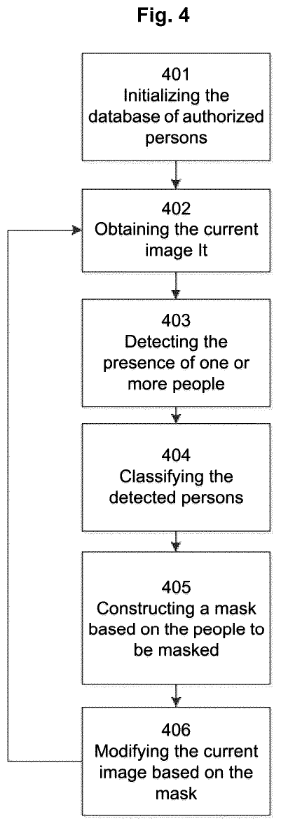

FIG. 4 is a flowchart of a method according to one or more exemplary embodiments. This flowchart is more detailed than the one in FIG. 2.

In 401, a database of authorized persons is initialized.

In one or more exemplary embodiments, the database comprises a vector identifying a person using data characteristic of that person's face. This database is stored, for example, in the working memory of the device 100.

In 402, the device 100 obtains a current image at time ‘t’, denoted I_t as above, during a video call.

In 403, the device 100 implements a method for detecting people in the current image I_t. This detection provides an output, for each person detected, particularly one or more parameters enabling each person to be characterized and distinguished from one another. The detection of people also provides information on the location of each person in the image.

In one or more non-limiting embodiments, this detection comprises:
Detecting bodies and faces in the image
A face-body association
A vectorization of the faces, the vectors being able to be compared with the vectors in the database and thus classified.

In 404, face vectors are classified in the database containing vectors of authorized persons. The classification indicates whether a person is authorized or not, that is whether that person should remain in the image or be masked.

In 405, the device 100 constructs a mask for the image I_t, denoted M_t, which, when combined with the image I_t, masks people who are to be masked, if such people have been detected.

In one or more embodiments, the mask M_t is a function of:
Classification results in 404
Output data for body and face detection in 403
The captured image I_t

In 406, the image S_t is generated as a function of the mask Mt, the image I_t and the image S_t−1, that is the modified image resulting from the previous iteration of the method in FIG. 4. The image S_t is also recorded.

The next image is then processed, returning to 402.

The various steps of the method shown in FIG. 4 will now be described in detail.

Step 401 comprises initializing a B_Temp database configured to allow a person to be classified as authorized or unauthorized.

In one exemplary embodiment, the database comprises a list of one or more authorized persons, with each authorized person having an identifier ‘i’ and a vector ‘D_ij’ associated with the person i, the vector comprising characteristics enabling person i to be distinguished from other persons. A person not on the list will be considered unauthorized by default.

In one embodiment, a person can be represented by a plurality of vectors (corresponding, for example, to different photos of the person's face).

In one exemplary embodiment, the database B_Temp is initialized by copying data from another database, B_Global, present in the non-volatile memory of the device 100. B_Global comprises, for example, a list of permanently authorized persons, and for each of these persons, a vector as described later.

The properties of vectors and their use for classification will be described in more detail later.

Step 402 comprises capturing a scene filmed by the camera 104. This is done, for example, during a video call. An image forms part of a sequence of video frames, each image in the sequence being processed successively as part of the method described, before transmission of the video made up of the processed, and where appropriate, modified images to one or more recipients.

Step 403 relates to detecting people in the image. It comprises the extraction of information required for the following steps, that is information needed to classify the people present, and information which helps to mask the people to be masked in the image, if any. In one exemplary embodiment, the latter information describes the parts of the image occupied by a person.

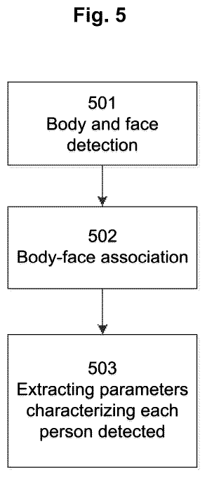

Three sub-steps 501 to 503 will be described, namely body and face detection (501), body-face association (502) and extraction of parameters characterizing each person (503). These sub-steps are shown in FIG. 5.

The purpose of step 501 is to detect bodies and faces in the image.

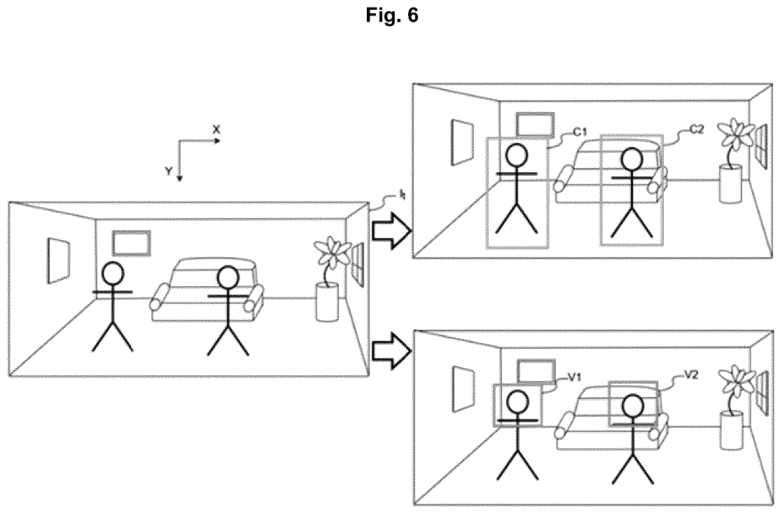

FIG. 6 is a schematic diagram showing body and face detection according to a particular embodiment. FIG. 6 shows an image I_t to be processed. Body detection delimits one or more areas C_i comprising bodies, and face detection delimits one or more areas V_i comprising faces. In the example shown in FIG. 6, the areas are rectangular areas, also known as bounding boxes, where V_i={(X_vi1, Y_vi1),(X_vi2,Y_vi2)} and C_i={(X_ci1, Y_ci1),(X_ci2,Y_ci2)} in the image reference frame.

In a particular embodiment, algorithms known per se are implemented for this body and face detection. The Viola-Jones method, also known as the ‘Haar cascade’, can be used to detect both bodies and faces. The ‘BlazeFace’ neural network [1] can also be used for face detection. For body detection, the ‘EfficientDet’ neural network [2] can be used. These two neural networks output the bounding boxes C_i and V_i. The ‘BlazeFace’ network outputs the coordinates of the face bounding boxes, as well as the positions of twelve landmarks (two for the mouth, four for the ears, four for the eyes and two for the nose). The ‘EfficientDet’ network outputs the number and type of objects detected, and the bounding boxes in the image.

In the example given, an area delimiting a body contains the entire body, that is also the face.

The purpose of step 502 is to achieve a consistent association of body ‘C_i’ and face ‘V_j’ for the same person ‘P_n’. We thus obtain sets P_n={V_i, C_j}.

This association can be made, for example, on the basis of the areas detected in the previous step. In a particular embodiment, the association of a face V_i and a body C_j comprises calculating the ratio between the area of intersection of the face V_i with the body C_j in relation to the area of the face V_i. A body C_j is associated with the face V_i with which it has the highest ratio.

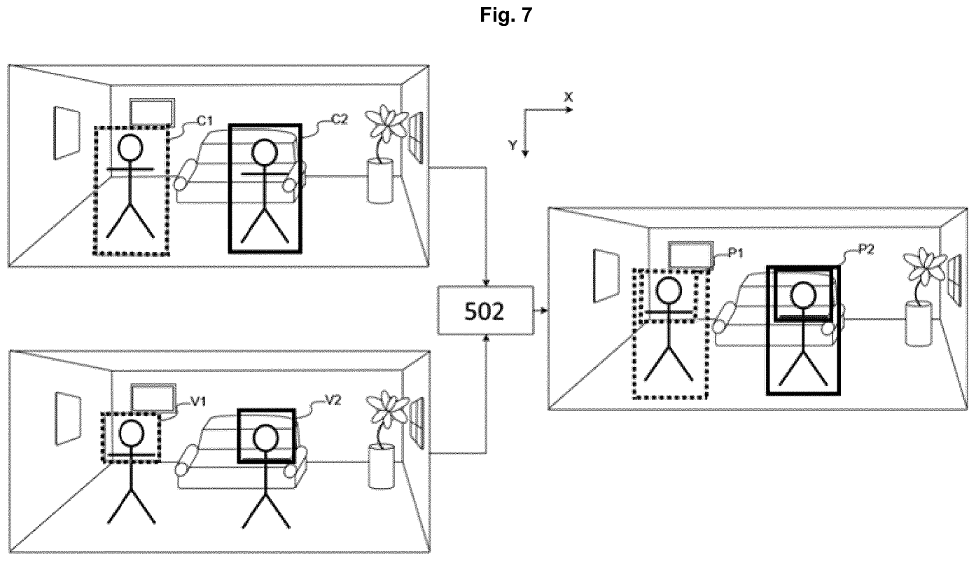

FIG. 7 is a schematic diagram showing the body-face association principle.

In one variant, a further condition is that the ratio is greater than a threshold. By way of illustration, in certain applications, this threshold may be equal to 0.7.

By way of example, the following pseudocode can be used to determine the association of a body with a face. Bodies are indexed with the indx_c index. Faces are indexed with the indx_v index, max_ratio represents the maximum ratio and max_indx represents the face index corresponding to the maximum ratio. max_indx and max_ratio are updated as the area ratio for a given body is calculated, in a loop in which each face is considered in turn. This face loop is made for each body.

| | |
|---|---|
| 1 | threshold = 0.7 |
| 2 | For indx_c, c in enumerate(body): |
| 3 | max_ratio = −1, max_indx = −1 |
| 4 | For indx_v, v in enumerate(faces): |
| 5 | ratio = surface(intersection(v,c)) / surface(v) |
| 6 | if ratio > max_ratio && ratio > threshold: |
| 7 | max_ratio = ratio; |
| 8 | max_indx = indx_v; |
| 9 | end if |
| 10 | end for |
| 11 | end for |

At the end of step 502, each person P_n is represented by a maximum of two bounding boxes, one for the face, the other for the body.

In one variant, in order to avoid associating the same face with several bodies, an associated face is excluded from iterations for the following body or bodies, that is once associated with a body, a face cannot be associated with another body.

In one variant, the case is considered where one or more faces are not associated with a body. This can happen, for example, if the detection of bodies and faces results in more faces than bodies. In this case, a person is only represented by a face, that is P_n={V_i}. We suggest associating a fictitious body with such a face, so that the person concerned is represented by both a face and a body, for the rest of the method.

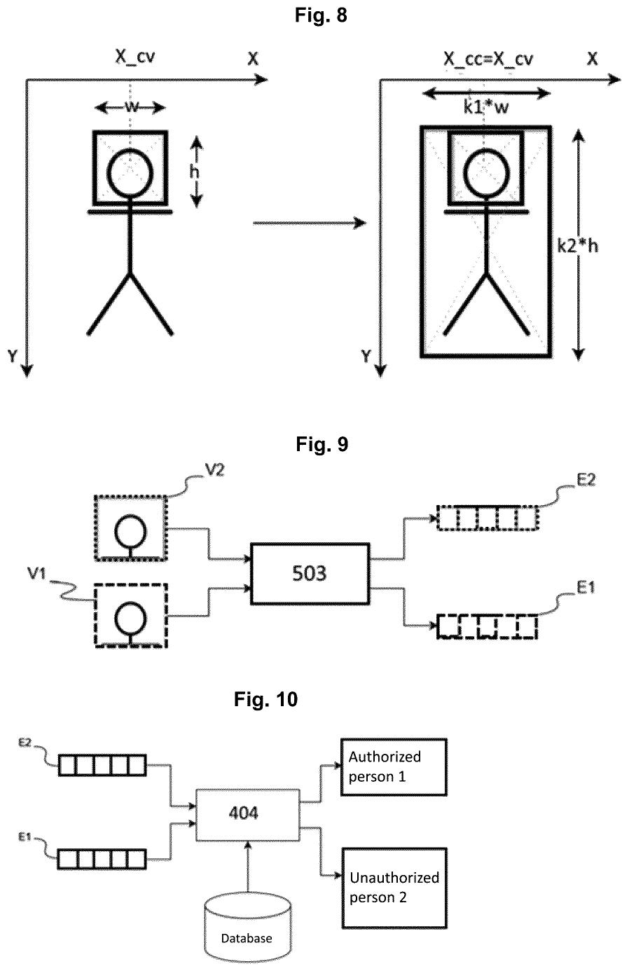

FIG. 8 is a schematic diagram showing the creation of a fictitious body for a non-associated face. In the example shown in FIG. 8, the dimensions of the fictitious body are a function of the size of the face. This is particularly easy to achieve when the face and body are considered to be bounded in rectangular boxes. The dimensions of the face's bounding box are w for width and h for height. The dimensions of the fictitious body's bounding box are calculated by multiplying the width w by a coefficient K1 and the height h by a coefficient K2. By way of a non-limiting example, K1 can be taken to be equal to 2 and K2 equal to 8. For example, if we denote the fictitious body by C′ and (X′_{cj1},Y′_{cj1}), (X′_{cj2},Y′_{cj2}) respectively the coordinates of the upper left and lower right points of the corresponding bounding box, we can obtain these coordinates by applying.

$$w = {X}_{vi 2} - {X}_{vi 1} \qquad [ Math . 1 ]$$

$$h = {Y}_{vi 2} - {Y}_{vi 1} \qquad [ Math . 2 ]$$

$${X}_{cj 1}^{′} = {X}_{vi 1} - \frac{( {X}_{vi 2} - {X}_{vi 1} ) \times ( 1 + K 1 )}{2} \qquad [ Math . 3 ]$$

$${Y}_{cj 1}^{′} = {Y}_{vi 1} \qquad [ Math . 4 ]$$

$${X}_{cj 2}^{′} = {X}_{vi 2} - \frac{( {X}_{vi 2} - {X}_{vi 1} ) \times ( 1 + K 1 )}{2} \qquad [ Math . 5 ]$$

$${Y}_{cj 2}^{′} = {Y}_{vi 1} + K 2 \times ( {Y}_{vi 2} - {Y}_{vi 1} ) \qquad [ Math . 6 ]$$

Other ways of determining a fictitious body are also possible.

In one embodiment, the surfaces corresponding to the bodies are detected, then for each body, the face corresponding to the inside of the body surface is detected.

The face detected in the body surface is then directly associated with the corresponding body.

Step 503 comprises extracting a face from the parameters characterizing a person.

In one embodiment, this step uses the principle of embedding, which comprises generating a vector of size N from an image in order to uniquely identify it. By calculating the distance between two vectors, that is two images, we can determine whether or not they are similar. In a non-limiting embodiment, a cosine distance calculation is used. However, other ways of calculating distance between vectors can also be used. Two faces whose vectors are close in distance identify the same person.

Vectorization is performed for V_i faces. This vectorization can be carried out using tools known in their own right. For example, the facial recognition neural network found in ‘Dlib’ [3], a state-of-the-art library of machine learning tools, can be used for vectorization. One implementation transforms a 150×150 pixel image into a vector of size 128.

At the end of this vectorization phase, each person P_i present in the scene is presented by two bounding boxes C_i and V_i, and a vector E_i of size N derived from face V_i, as shown in FIG. 9, which is a schematic diagram showing the derivation of two vectors E1 and E2 from respective faces V1 and V2.

Optionally, a face bounding box is pre-processed before vectorization. This pre-processing consists of straightening or aligning the face using the landmarks in the face. This alignment makes it possible to obtain vectors with smaller distances for different images of the same person's face. Alignment consists of transforming the image of the face, for example by rotating it, so that it is substantially vertical.

Returning to the method whose flowchart is shown in FIG. 4, a classification of the faces is performed in 404, comprising the determination, for each person detected, of whether that person is an authorized or unauthorized person.

In one embodiment, this step comprises using the previously obtained E_i vectors. FIG. 10 is a schematic diagram showing the classification principle according to one or more embodiments.

The database B_Temp can be built up in different ways and change over time. Please note that the various options below are not mutually exclusive and can be combined in the same implementation.
The database B_Temp can be initialized with data from another database (see above).
The database B_Temp can be augmented with the people present at the start of the video call, for example in the first thirty seconds. These people are then automatically authorized persons. For each of these people, one or more vectors E are stored in B_Temp.

These people are then authorized for the duration of the video communication, or in one variant, for as long as they do not leave the filmed scene.

In the event that B_Temp is initially not empty, the device 100 determines for each vector E_i whether the database comprises a vector close enough to conclude that vector E_i corresponds to a person listed in the database. In this example, the device 100 calculates the distance between each vector E_i and the vectors D_j already present in B_Temp. If for a vector E_i, a vector D_j is close enough—for example, the cosine distance is less than a threshold E, (with for example ε=0.1)—person “i” is considered authorized. Conversely, if for a vector E_i, no nearby vector is found in the database, then person “i” is considered unauthorized.

Optionally, if a person is determined not to be authorized, the user is asked if they wish to add this person as an authorized person in the database B_Temp.

Optionally, at the end of a video call, the user is asked if they wish to add one or more persons present in the temporary database B_Temp but not yet present in the permanent database B_Global to the permanent database B_Global.

Optionally, a user interface is provided so that a user can edit the database B_Global, this editing comprising the possibility of removing authorized persons.

In one variant, persons for whom no face is detected in 403 will automatically be considered unauthorized.

The criterion that all persons present in the database B_Temp are considered authorized is not restrictive: Alternatively, it is possible to implement a mechanism for constructing a subset P′K of authorized persons from the set of persons Pi present in the database, so as to authorize only a subset of persons. This construction can be based on one or more criteria, such as the type of communication, with certain people indicated in the database as being authorized for certain types of communication only.

Steps 405 and 406 comprise processing the image I_t to render unauthorized persons invisible.

In one exemplary embodiment, this processing comprises creating a mask (405) and applying the mask to the image (406). Other implementations can be envisaged, notably in a single step.

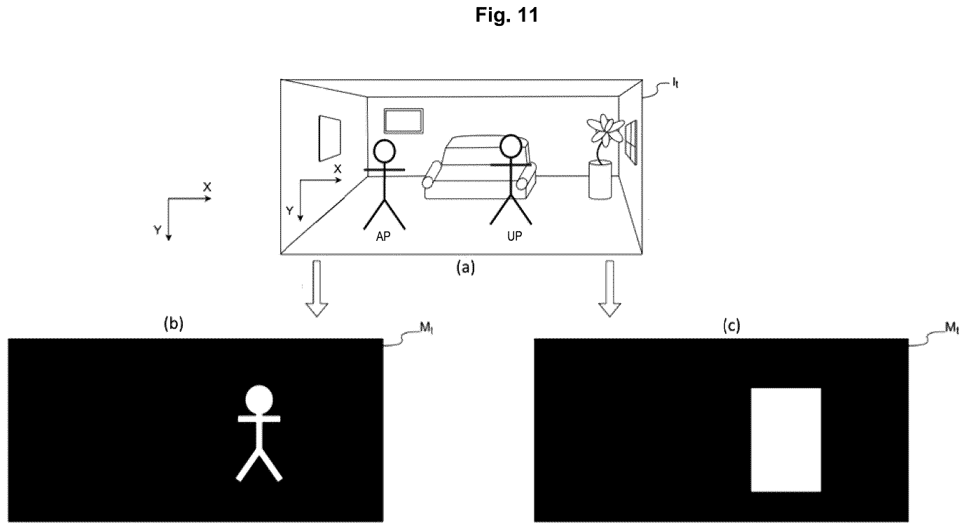

FIG. 11 is a schematic diagram comprising an image (a), which is a current image I_t, an image (b) which is a mask resulting from a segmentation of image (a) according to a first variant and an image (c) resulting from a second variant. The first variant comprises semantic segmentation of the image, while the second embodiment does not comprise semantic segmentation.

A mask is a binary image used to define a set of pixels of interest in an original image. For example, the mask is, for instance, defined by:
Mask (i,j)=1 if pixel Image(i,j) is a pixel of interest, and
Mask (i,j)=0 otherwise.

In the present example, the original image is the image I_t and the pixels of interest are the pixels corresponding to unauthorized persons. The mask has the same dimensions as the image I_t, but in other implementations this is not necessarily the case. For example, the original image may result from a resizing of the image I_t, and the mask will then be smaller or larger in pixel terms than the image I_t.

The mask construction step 404 implements the results of the detection step 403 and of the classification step 404.

In the first variant, a segmentation algorithm known per se can be used to construct the mask. The pixels of interest then relate quite precisely to the part of the image corresponding to the person. This algorithm can be based on neural networks, such as the DeepLabV3 algorithm [4].

The second variant does not use semantic segmentation. For example, the mask is obtained by considering the pixels of the bounding boxes corresponding to a person as pixels of interest. This variant has the advantage of being less demanding in terms of computing resources.

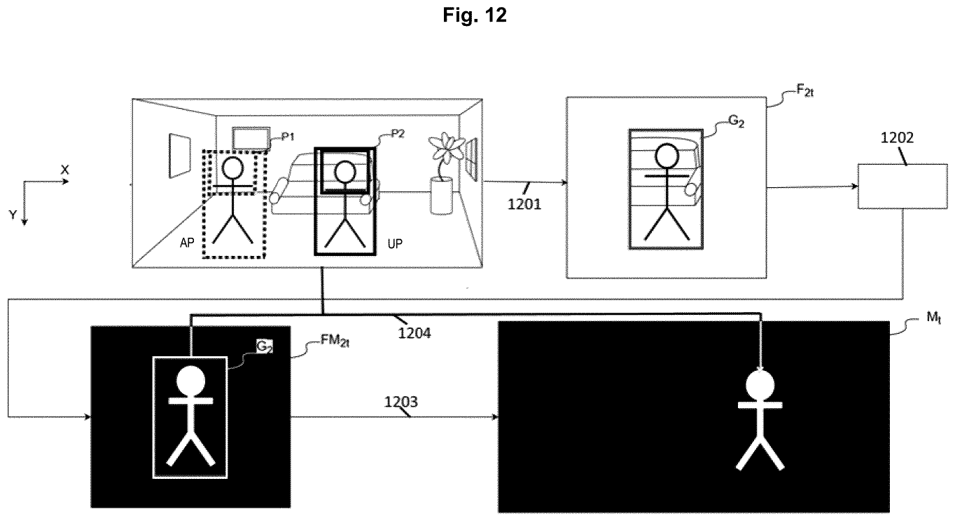

The construction of a mask according to the first embodiment will now be described. Semantic segmentation comprises associating a label with each image pixel. In this example, the label of interest is the label ‘Person’. FIG. 12 is a schematic diagram showing the various stages in the construction of a mask implementing semantic segmentation according to one exemplary embodiment.

First, the image areas containing the unauthorized persons in the original image are extracted 1201. These areas are each placed in an intermediate image F_it, in this case F_2t in the example shown. Extraction is performed using the coordinates of the bounding boxes of the faces and bodies of those people. The process first finds the coordinates of the extraction bounding boxes called “G_i”, defined by:
X_1Gi=min(X_ci1, X_vi1)
Y_1Gi=min(Y_ci1, Y_vi1)
X_2Gi=max(X_ci2, X_vi2)
Y_2Gi=max(Y_ci2, Y_vi2)
where V_i and C_i are the bounding boxes for the face and body of the person P_i classified as unauthorized. The size of the intermediate image F_it is then defined. In this implementation, F_it is an image where all pixels have the same color (white, in the example in FIG. 12). This image has, for example, an aspect ratio of 1:1 and a height of K*max((Y_2Gi−Y_1Gi), (X_2Gi−X1_Gi)). For example, K can be set equal to 2, by way of illustration. The process then places the bounding box “G_it”, extracted from image I_t, in the center of image F_it. The F_it images then go to the segmentation step 1202 to generate masks FM_it. The “G_i” extraction bounding boxes are then used in 1203 to extract the pixels of interest from the FM_it, and place them in M_t. Reference 1204 indicates the placement of the parts of interest FM_it in M_t at the same position as in image I_t.

In the first embodiment, the mask is constructed without semantic segmentation. In this variant, the bounding boxes G_i, and constructs the mask M_t are obtained, simply by considering that all pixels inside these boxes correspond to unauthorized persons and are therefore pixels of interest.

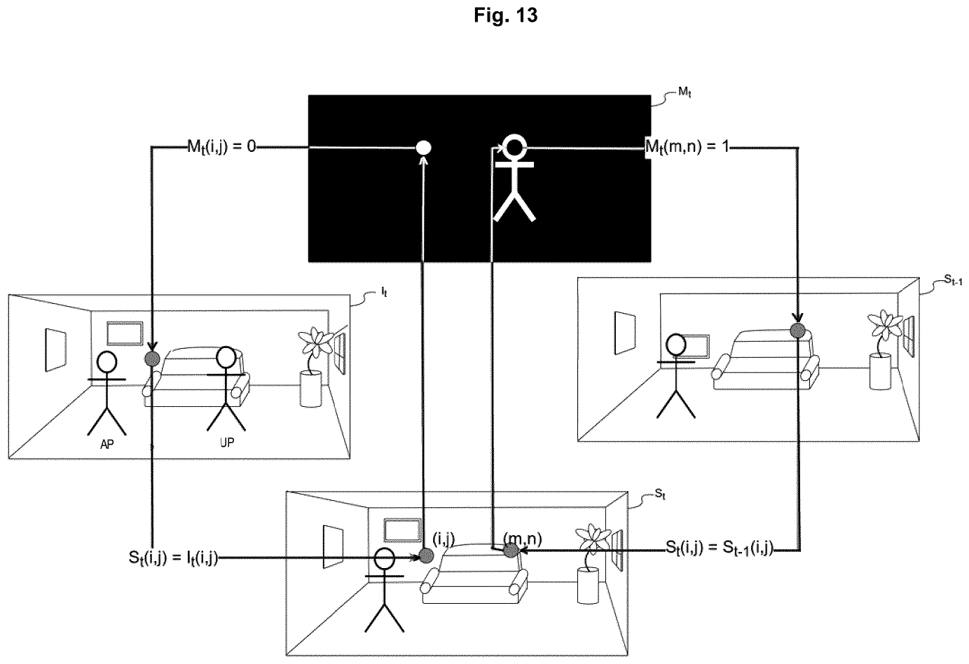

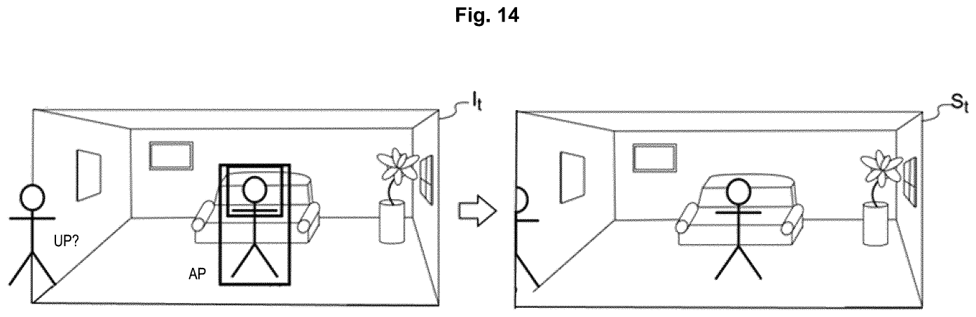

Once the mask M_t has been constructed, the final processed image S_t can be obtained. FIG. 13 is a schematic diagram showing the composition of the final image.

The input data for this step comprises:
the generated mask M_t;
the image S_t−1 sent at time t−1;
the image I_t captured at time t.

To construct the image S_t, the following formula is applied: S_t=M_t*S_t−1+(1−M_t)*I_t.

This formula means that:
1. The value of pixel (i,j) in image S_t is equal to pixel (i,j) in image I_t if M_t(i,j)=0.
2. The value of pixel (i,j) in image S_t is equal to pixel (i,j) in image S_t−1 if M_t(i,j)=1.

The image S_t is stored in volatile memory for the next iteration.

FIG. 13 is a schematic diagram showing the composition of the image S_t.

In one embodiment, images S_t−1 are initialized (at t=0) with an image of the scene filmed by the camera without people. In another embodiment, the people present at the start of the communication are automatically authorized. In yet another embodiment, the initial image S_0 is simply a black image.

Deleting a person from an image requires prior detection. Poor detection, or non-detection, can produce undesirable visual effects. One case where this problem can arise is when a person is partially visible in the filmed scene, for example when that person is positioned on the edge of the image I_t and is only partially captured by the camera. FIG. 14 is a schematic diagram showing the captured image I_t and the resulting image S_t, where a potentially unauthorized person straddles the edge of the image I_t and is not erased in the image S_t.

In one embodiment, image processing comprises cropping that eliminates bands around the image to be transmitted, that is at least the sidebands on both sides and in some embodiments also bands above and below. In the examples shown above, this cropping is applied to image S_t—the result is image S′_t. The width of the deleted bands is chosen so that a person entering the image does not appear in the cropped image—at least if the person enters from an edge of the image. The width of the deleted bands can also simply be a percentage of the dimensions, for example 5% of the image width or height. Cropping creates a wider detection margin, to increase the chances of good detection for people at the edge of the unprocessed image.

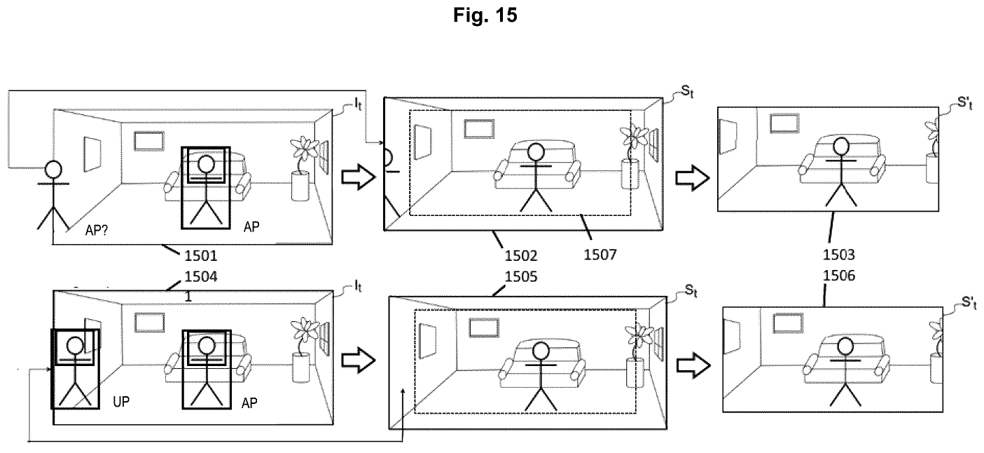

FIG. 15 is a schematic diagram of a method for reducing the impact of the above-mentioned problem.

Images 1501 to 1503 show an example in which it is not possible to detect a person and determine whether that person (‘AP?’) is authorized or not. In image 1501, this person is only halfway inside the image I_t. The processing described above is then applied to the image 1501 to produce the processed image 1502. In the case of the image 1501, the person at the edge of the image is not detected and therefore not deleted. Cropping is performed to eliminate at least the sidebands. In the resulting image S′_t 1503, the undetected person does not appear. The image S′_t will be transmitted.

Images 1504 to 1506 show an example in which it is possible to detect the person entering the filmed scene. The image 1504 may correspond to the situation in image 1501—the person has moved towards the center of the room. The area of the face detected is then sufficient to determine the person's authorized/unauthorized status. In the example of images 1504 to 1506, this person is not authorized. In processed image 1505, the person will have been rendered invisible by applying the processing described above. However, the image is cropped to obtain an image S′_t 1506 in the same format as image 1503. If the unauthorized person enters the room further, they will remain invisible in subsequent S′ images.

It should be noted that blurring does not erase a person (render the person invisible), in the sense of the absence of graphic information about that person.

In a particular embodiment, the real background of the image, as filmed by the camera, is replaced by a virtual background. The processing applied is similar to that shown in FIG. 4, with the following modifications:

In step 404:
The mask is constructed using semantic segmentation.
The authorized person(s) becomes the element(s) of interest, and the mask(s) is obtained for that person(s) and not the unauthorized person(s).

In step 405:
The image S_t is composed using the mask M_t, the image captured at time t, I_t, and a virtual background image.

In step 406:
The transmitted image S_t does not need to be stored in memory for processing the next captured image.

In one embodiment, it is possible to switch between the real background of the camera image and a virtual background.

The facial landmarks are specific points on the face of a human being. These points are often placed around the face, eyes and mouth. Such points can be located using image processing methods known per se. The number of points used depends on the application and context. There are models, such as the one used by the ‘Blazeface’ algorithm mentioned above, based on six points. The ‘DLib’ tool mentioned above contains tools capable of using sixty-eight points.

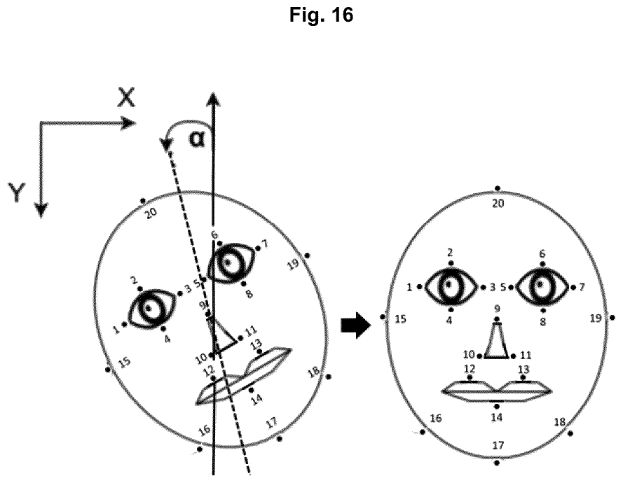

As mentioned previously, to improve facial vectorization, a facial alignment can be performed prior to vectorization. FIG. 16 is a schematic flowchart showing the alignment of a face according to one or more exemplary embodiments. The face in FIG. 16 comprises twenty landmarks. The principle of alignment consists in straightening the face to place landmarks along a line that are symmetrical in relation to the vertical symmetry axis of the face, such as points 2 and 6 above the eyes, or landmarks that should be on the symmetry axis of the face, such as points 17 and 20. From these points, an alpha rotation angle of the face with respect to the vertical is determined. The image of the face is then transformed by an alpha angle rotation operation to straighten it vertically.

One example relates to a video communication method implemented by a device (100) comprising a processor (107) and a memory (105) comprising software code, the processor executing the software code causing the device to implement the method, the method comprising:
obtaining (201) an image (I_t) generated by a camera;
detecting (202) one or more people (AP, UP) in the image;
in the event that one or more persons are detected, checking (203) for each person a criterion indicating whether the person should or should not be part of the video communication;
processing (204) the image to erase from the image the detected person(s) who should not be part of the video communication;
transmitting (205) the processed image (S_t, S′_t).

### REFERENCES

[1] Bazarevsky et al, ‘BlazeFace’—Article “BlazeFace: Sub-millisecond Neural Face Detection on Mobile GPUs”—Jul. 14, 2019—https://arxiv.org/abs/1907.05047 An implementation is available at https://developers.google.com/mediapipe/solutions/vision/face_detector
[2] Tan et al, ‘EfficientDet’—Article “EfficientNet: Rethinking Model Scaling for Convolutional Neural Networks”—Sep. 11, 2020—https://arxiv.org/abs/1905.11946
[3]‘DLib’https://github.com/davisking/dlib-models, including dlib_face_recognition_resnet_model_v1 for embedding and shape_predictor_68_face_landmarks for detecting facial landmarks.
[4] Chen et al, ‘Rethinking Atrous Convolution for Semantic Image Segmentation’—Dec. 5, 2017—https://arxiv.org/abs/1706.05587

An implementation of DeepLabV3 is available at https://tfhub.dev/tensorflow/lite-model/deeplabv3/1/metadata/2

1. A video communication method implemented by a device comprising a processor and a memory comprising software code, the processor executing the software code causing the device to carry out the method, the method comprising:
obtaining an image generated by a camera;
detecting one or more people in the image;
in the event that one or more persons are detected, checking for each person a criterion indicating whether the person should or should not be part of the video communication;
processing the image to erase from the image the detected person(s) who should not be part of the video communication;
the method comprising, following the processing of the image to erase from the image detected person(s) who should not be part of the video communication, cropping the processed image to obtain a cropped processed image, the cropping being configured to remove at least left and right sidebands from the processed image, the sidebands being of a width adapted to contain one or more persons before it becomes possible to detect them, the transmission being performed with the cropped processed image.

2. The method according to claim 1, wherein detection comprises identifying one or more first areas of the image, each first area comprising a face.

3. The method according to claim 2, wherein the detection further comprises:
identifying one or more second areas of the image, each second area comprising a body;
associating, according to an association criterion, a first area and a second area to form a representation of a person in the image.

4. The method according to claim 3, comprising, for a given first area not associable with a second area on the basis of the association criterion, determining a third area, where the third area is an area of the image dependent on the given first area and intended to serve as a second area associated with the given first area to form a representation of a person in the image for image processing.

5. The method according to claim 3, comprising, when a second area cannot be associated with a first area, marking this second area as part of a person who should not participate in the video communication, the representation of this person then comprising only the second area.

6. The method according to claim 3, comprising extracting, from each first area, characteristic parameters of the face of each first area, said characteristic data being adapted to enable to determine, from a database, whether a person corresponding to a face should or should not be part of the video communication.

7. The method according to claim 6, said database comprising:
either characteristic face parameters for one or more persons authorized to participate in the video communication;
or at least one of:
characteristic parameters for one or more faces and, for each face, an indication that the person corresponding to the face should be part of the video communication; and
characteristic parameters for one or more faces, and for each face, an indication that the person corresponding to the face should not be part of the video communication.

8. The method according to claim 7, comprising initializing the database with data stored in advance.

9. The method according to claim 7, comprising augmenting the database by:
identifying one or more first areas comprising a face, during a time interval from the start of the video communication;
extracting, from each first area, characteristic parameters of the face of each first area;
storing the characteristic face parameters of the face of each first area with a respective indication that the person corresponding to the face should be part of the video communication.

10. The method according to claim 3, the image processing comprising
obtaining a mask from representations of people who should not be part of the video communication;
obtaining a processed image as a function of the mask, the image obtained from the camera and a processed image obtained previously.

11. A device comprising a processor and a memory comprising software code, the processor executing the software code causing the device to implement a method according to claim 1.

12. A television decoder comprising a device according to claim 11.

13. A non-transitory computer-readable storage medium comprising instructions which, when executed by at least one processor, cause said at least one processor to execute the method of claim 1.
